(19) United States
(12) Patent Application Publication
(10) Pub. No.: US 2017/0188035 A1
(43) Pub. Date: Jun. 29, 2017

(54) TRANSCODING METHOD AND ELECTRONIC APPARATUS

(71) Applicants: LE HOLDINGS (BEIJING) CO., LTD., Beijing (CN); LECLOUD COMPUTING CO., LTD., Beijing (CN)

(72) Inventors: Yangang CAI, Beijing (CN); Maosheng BAI, Beijing (CN); Hai QI, Beijing (CN); Fang YANG, Beijing (CN); Yang LIU, Beijing (CN); Wei WEI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/246,415

(22) Filed: Aug. 24, 2016

Related U.S. Application Data
(63) Continuation of application No. PCT/CN2016/088688, filed on Jul. 5, 2016.

(30) Foreign Application Priority Data
Dec. 25, 2015 (CN) 201510998049.5

(51) Int. Cl. H04N 19/40; H04N 19/103; H04N 19/176; H04N 19/64; H04N 19/12

(52) U.S. Cl. CPC H04N 19/40; H04N 19/647; H04N 19/12; H04N 19/176; H04N 19/103

(57) ABSTRACT

Disclosed are a transcoding method and electronic apparatus. The method includes: obtaining 16 H.264 video macro blocks; determining encoding type of the 16 H.264 video macro blocks; transcoding the 16 H.264 video macro blocks into a H.265 coding tree unit CTU according to preset intra-frame transcoding correspondence if the encoding type of the 16 H.264 video macro blocks is intra-frame coding; transcoding the 16 H.264 video macro blocks into one H.265 CTU according to preset inter-frame transcoding correspondence if the encoding type of the 16 H.264 video macro blocks is inter-frame coding. The device includes: capturing module, determination module, first transcoding module and second transcoding module. The present invention has no need to decode H.264 video macro blocks to produce original video data, so the transcoding process can speed up and save time.

### CROSS REFERENCE TO RELATED APPLICATIONS

This application is a continuation of International Application No. PCT/CN2016/088688, filed on Jul. 5, 2016, which is based upon and claims priority to Chinese Patent Application No. 201510998049.5, filed on Dec. 25, 2015, the entire contents of which are incorporated herein by reference.

### TECHNICAL FIELD

The application relates to a computer network communication filed, more particularly to a transcoding method and electronic apparatus.

### BACKGROUND

With the development of computer network communication technology, videos have become the most important media for the dissemination and presentation of information. For the convenient dissemination and presentation of videos, video data is usually compressed and encoded. In the past, mainstream encoders were based on H.264 (also known as advanced video coding (AVC)) encoding standard in the industry. H.265 (also known as high efficiency video coding (HEVCH)) can save about 50% bit rate as providing a bit stream having the same quality as H.264. It can be predicted that H. 265 will be widely applied to many fields and become blooming splendor in the industry in the feature because of its high compression efficiency. For this reason, the more interesting now is how to fast transcode H.264 into H.265.

Recently, a typical transcoding method is: encoding original video blocks into H.265 video blocks after H.264 video blocks are decoded into these original video blocks.

Such a modern transcoding method is decoding in whole and encoding in whole and will take a very long time.

### SUMMARY

The object of the present invention is to provide a transcoding method and electronic apparatus to resolve the technical problem in the art where transcoding H.264 video blocks into H.265 video blocks takes a long time.

To resolve the above technical problem, an embodiment of the disclosure provides a transcoding method including:
obtaining 16 H.264 video macro blocks;
determining encoding type of the 16 H.264 video macro blocks;
transcoding the 16 H.264 video macro blocks into a H.265 coding tree unit (CTU) according to preset intra-frame transcoding correspondence if the encoding type of the 16 H.264 video macro blocks is intra-frame coding;
transcoding the 16 H.264 video macro blocks into one H.265 CTU according to preset inter-frame transcoding correspondence if the encoding type of the 16 H.264 video macro blocks is inter-frame coding.

To resolve the above technical problem, the application further provides a transcoding device including: capturing module configured to capture 16 H.264 video macro blocks;
determination module configured to determine encoding type of the 16 H.264 video macro blocks;
first transcoding module configured to transcode the 16 H.264 video macro blocks into a H.265 coding tree unit CTU according to preset intra-frame transcoding correspondence if the encoding type of the 16 H.264 video macro blocks is intra-frame coding;
second transcoding module configured to transcode the 16 H.264 video macro blocks into a H.265 CTU according to preset inter-frame transcoding correspondence if the encoding type of the 16 H.264 video macro blocks is inter-frame coding.

The present invention further discloses a transcoding apparatus including: memory, processor, wherein,
the memory configured to store one or more instructions, wherein the one or more instructions are executable by the processor;
the processor configured to obtain 16 H.264 video macro blocks; determine encoding type of the 16 H.264 video macro blocks; transcode the 16 H.264 video macro blocks into a H.265 coding tree unit (CTU) according to preset intra-frame transcoding correspondence if the encoding type of the 16 H.264 video macro blocks is intra-frame coding; transcode the 16 H.264 video macro blocks into one H.265 CTU according to preset inter-frame transcoding correspondence if the encoding type of the 16 H.264 video macro blocks is inter-frame coding.

As compared to the art, the present invention can have the following technical effects including:
transcoding 16 H.264 video macro blocks into a H.265 coding tree unit CTU according to preset intra-frame transcoding correspondence if encoding type of 16 H.264 video macro blocks is intra-frame coding; transcoding 16 H.264 video macro blocks into a H.265 coding tree unit CTU according to preset inter-frame transcoding correspondence if encoding type of 16 H.264 video macro blocks is inter-frame coding, so that since it is necessary to decode H.264 video macro blocks to produce original video data, the transcoding process can speed up and save time.

### BRIEF DESCRIPTION OF THE DRAWINGS

To illustrate the technical solutions in the embodiments of the present invention more clearly, the following briefly introduces the accompanying drawings required for describing the embodiments. Apparently, one or more embodiments are illustrated by way of example, and not by limitation in the figures of the accompanying drawings, wherein elements having the same reference numeral designations represent like elements throughout. The drawings are not to scale, unless otherwise disclosed.

FIG. 1 is a flow chart of a transcoding method provided by an embodiment of the present invention;

FIG. 2 is a flow chart of the first transcoding method in the intra-frame coding in an embodiment of the present invention;

FIG. 3 is a flow chart of the first transcoding method in the inter-frame coding in an embodiment of the present invention;

FIG. 4 is a flow chart of the second transcoding method in the intra-frame coding in an embodiment of the present invention;

FIG. 5 is a schematic view of transcoding in the intra-frame coding in an embodiment of the present invention;

FIG. 6 is a flow chart of the third transcoding method in the intra-frame coding in an embodiment of the present invention;

FIG. 7 is a flow chart of the fourth transcoding method in the intra-frame coding in an embodiment of the present invention;

FIG. 8 is a flow chart of the second transcoding method in the inter-frame coding in an embodiment of the present invention;

FIG. 9 is a schematic view of transcoding in the inter-frame coding in an embodiment of the present invention;

FIG. 10 is a flow chart of the third transcoding method in the inter-frame coding in an embodiment of the present invention;

FIG. 11 is a flow chart of the fourth transcoding method in the inter-frame coding in an embodiment of the present invention;

FIG. 12 is a structural diagram of a transcoding device in an embodiment of the present invention;

FIG. 13 is a structural diagram of an electronic apparatus of transcoding in an embodiment of the present invention.

### DETAILED DESCRIPTION

The present invention will be described in further detail with reference to some embodiment and the attached drawings, so that the object, solution and advantages will become more apparent. In an example implementation of the present techniques, a computing device includes one or more processors or central processing units (CPUs), input/output interfaces, network interfaces, and memories.

The memory may include non-permanent memory, random access memory (RAM) and/or nonvolatile memory, e.g., read-only memory (ROM) or flash memory (flash RAM) as used in a computer readable medium. The memory can be regarded as an example of a computer readable medium.

The computer readable medium includes permanent and non-permanent as well as removable and non-removable media capable of accomplishing a purpose of information storage by any method or technique. The term of information may be referred to as computer executable instructions, a data structure, a program module or any kind of data. Examples of the computer storage medium may include, but are not limited to, phase-change memory (PRAM), static random-access memory (SRAM), dynamic random access memory (DRAM), other types of random access memory (RAM), read-only memory (ROM), electrically-erasable programmable read-only memory (EEPROM), flash memory or any other memory technologies, compact disc read-only memory (CD-ROM), digital versatile disk (DVD) or any other optical storage media, cassette tape, diskette or any other magnetic storage device, or any other non-transmission medium which can be used to store information and accessed by the computing device. As defined herein, the computer readable medium does not include transitory medium such as a modulated data signal and a carrier wave.

Certain terms are used throughout the following descriptions and claims to refer to particular system components. As one skilled in the art will appreciate, hardware manufacturers may refer to a component by different names. This document does not intend to distinguish between components that differ in name but not differ in functionality. In the following discussion and in the claims, the terms “include”, “including”, “comprise”, and “comprising” are used in an open-ended fashion, and thus should be interpreted to mean “including, but not limited to.” “Substantially” means that those skilled in the art, within an acceptable error range, can solve said problems within a certain error range, and basically achieve said technical effects. Moreover, the terms “couple” and “coupled” are intended to mean either an indirect or a direct electrical connection. Thus, if a first device couples to a second device, that connection may be through a direct electrical connection, or through an indirect electrical connection via other devices and connections. The following detailed description is of the best currently contemplated modes of carrying out the invention. However, the description is not to be taken in a limiting sense, but is made merely for the purpose of illustrating the general principles of the invention. The scope of the invention is best defined by the appended claims.

It also needs to be explained that the term “comprising”, “including” or any other variation thereof is intended to cover a non-exclusive inclusion, such that a product or a system comprising/including a series of elements not only comprises/includes those elements, but also comprises/includes other elements not expressly listed, or further comprises/includes elements inherent for such a product or system. In the absence of more restrictions, an element defined by the statement “comprising/including a . . . ” does not exclude the existence of additional identical elements in the product or system comprising/including the element.

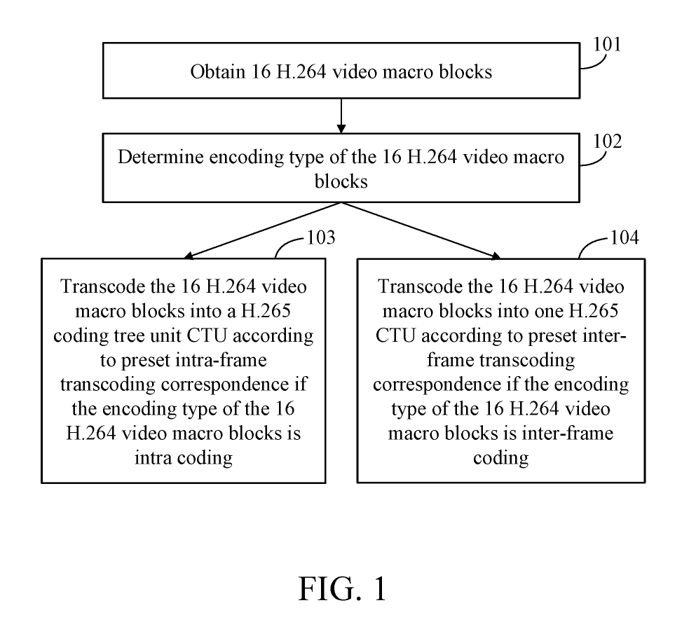

FIG. 1 illustrates a transcoding method provided in an embodiment of the present invention, which includes the following steps:

S101: obtaining 16 H.264 video macro blocks.

Particularly, the size of a H.264 video macro block is 16×16, H.265 uses a fixed CTU (coding tree blocks, coding tree unit) format with a CTU size of 64×64, and thus, 16 H.264 video macro blocks correspond to one H.265 coding tree unit CTU.

S102: determining encoding type of the 16 H.264 video macro blocks.

Particularly, the encoding type includes intra-frame coding and inter-frame coding.

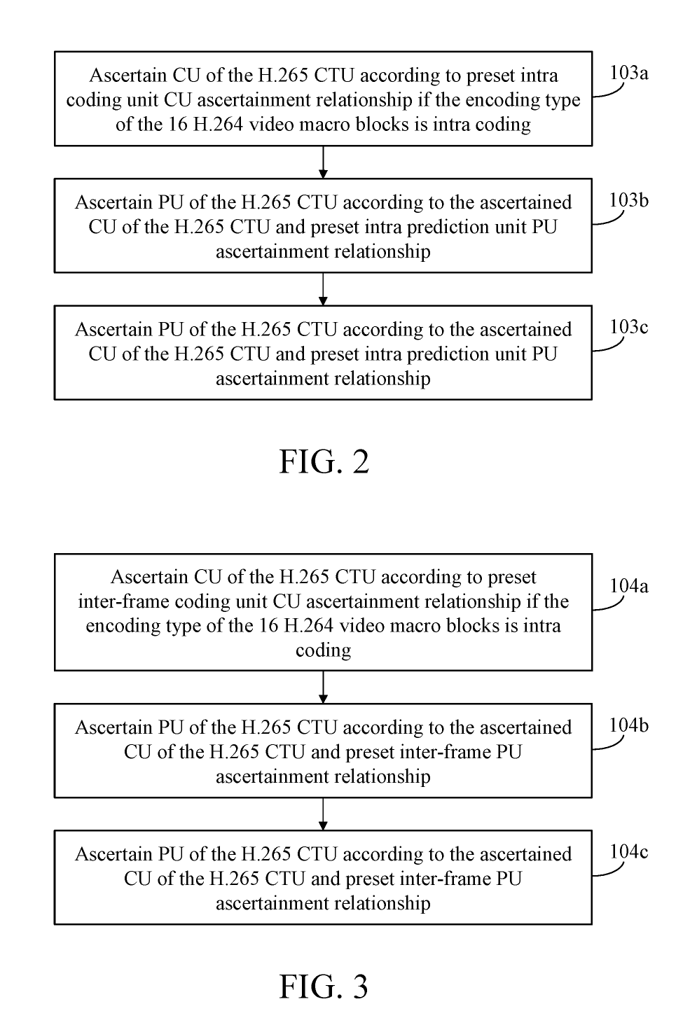

S103: transcoding the 16 H.264 video macro blocks into a H.265 coding tree unit CTU according to preset intra-frame transcoding correspondence if the encoding type of the 16 H.264 video macro blocks is intra-frame coding.

Wherein, in reference with FIG. 2, if the encoding type of the 16 H.264 video macro blocks is intra-frame coding, transcoding the 16 H.264 video macro blocks into a H.265 coding tree unit CTU according to preset intra-frame transcoding correspondence includes:

S103a: ascertaining CU of the H.265 CTU according to preset intra-frame coding unit (CU) ascertainment relationship if the encoding type of the 16 H.264 video macro blocks is intra-frame coding;

S103b: ascertaining PU of the H.265 CTU according to the ascertained CU of the H.265 CTU and preset intra prediction unit PU ascertainment relationship;

S103c: ascertaining transform unit (TU) of the H.265 CTU according to the ascertained CU of the H.265 CTU and preset transformation unit TU ascertainment relationship.

S104: transcoding the 16 H.264 video macro blocks into one H.265 CTU according to preset inter-frame transcoding correspondence if the encoding type of the 16 H.264 video macro blocks is inter-frame coding.

Wherein, referring to FIG. 3, if the encoding type of the 16 H.264 video macro blocks is inter-frame coding, transcoding the 16 H.264 video macro blocks into one H.265 CTU according to preset inter-frame transcoding correspondence includes:

S104a: ascertaining CU of the H.265 CTU according to preset inter-frame coding unit CU ascertainment relationship if the encoding type of the 16 H.264 video macro blocks is inter-frame coding;

S104b: ascertaining PU of the H.265 CTU according to the ascertained CU of the H.265 CTU and preset inter-frame PU ascertainment relationship;

S104c: ascertaining TU of the H.265 CTU according to the ascertained CU of the H.265 CTU and preset transformation unit TU ascertainment relationship.

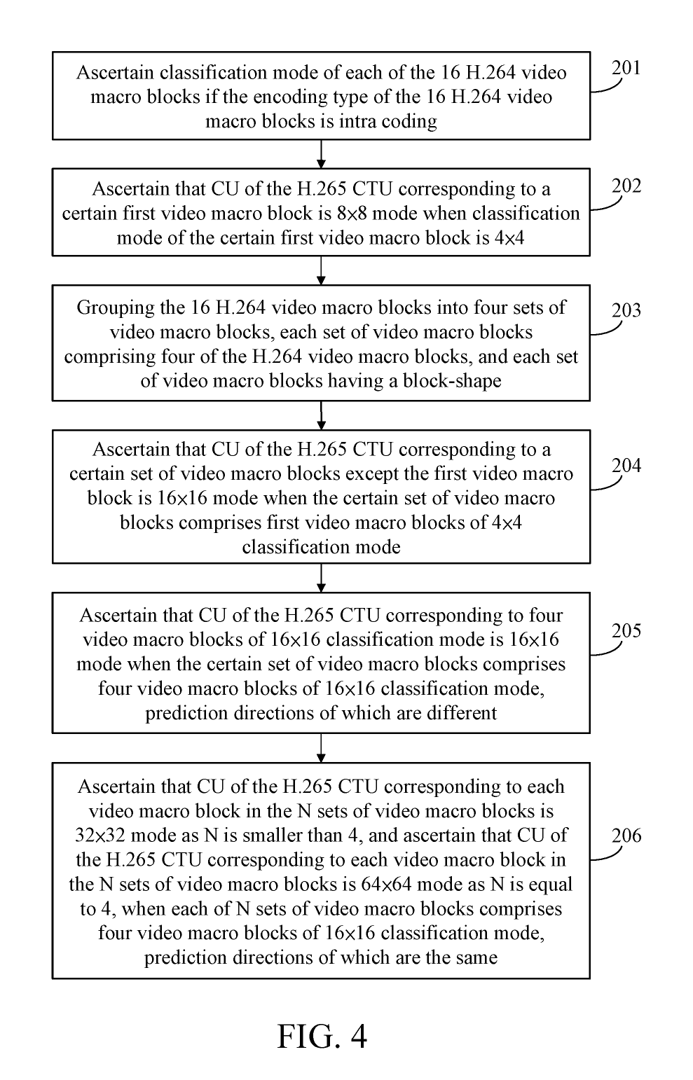

Particularly, referring to FIG. 4, in S103a, if the encoding type of the 16 H.264 video macro blocks is intra-frame coding, ascertaining CU of the H.265 CTU according to preset intra-frame coding unit CU ascertainment relationship includes:

S201: ascertaining classification mode of each of the 16 H.264 video macro blocks if the encoding type of the 16 H.264 video macro blocks is intra-frame coding.

Particularly, there are two classification modes for each H.264 video macro block (16×16) during intra-frame coding: 16×16 classification mode where one 16×16 sub-block constitutes a macro block, and 4×4 classification mode where 16 4×4 sub-blocks constitute a macro block.

S202: ascertaining that CU of the H.265 CTU corresponding to a certain first video macro block is 8×8 mode when classification mode of the certain first video macro block is 4×4.

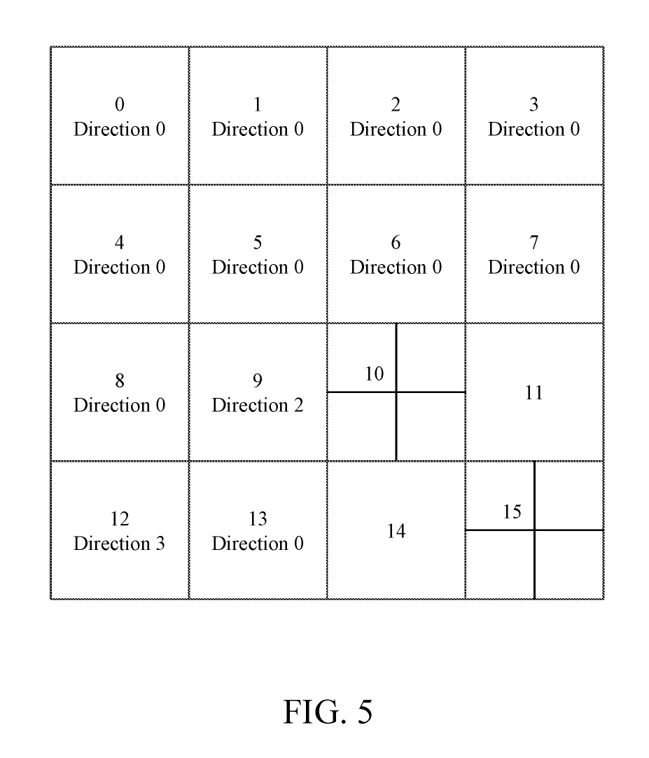

Particularly, referring to FIG. 5, among 16 H.264 video macro blocks (0, 1, 2, 3, 4, 5, 6, 7, 8, 9, 10, 11, 12, 13, 14, 15), assume 10, 15 are 4×4 classification mode, and thus, CUs corresponding to 10, 15 are ascertained to be 8×8 mode.

S203: grouping the 16 H.264 video macro blocks into four sets of video macro blocks, each set of video macro blocks including four H.264 video macro blocks, and shape of each set of video macro blocks is square.

Particularly, referring to FIG. 5, 16 H.264 video macro blocks (0, 1, 2, 3, 4, 5, 6, 7, 8, 9, 10, 11, 12, 13, 14, 15) are grouped into four sets of video macro blocks, including: {0, 1, 4, 5}, {2, 3, 6, 7}, {8, 9, 12, 13} and {10, 11, 14, 15}.

S204: ascertaining that CU of the H.265 CTU corresponding to a certain set of video macro blocks except the first video macro block is 16×16 mode when the certain set of video macro blocks comprises first video macro blocks of 4×4 classification mode.

For example, referring to FIG. 5, in the fourth set {10, 11, 14, 15}, 10, 15 are 8×8 mode as 11, 14 are directly ascertained to be 16×16 mode.

S205: ascertaining that CU of the H.265 CTU corresponding to four video macro blocks of 16×16 classification mode is 16×16 mode when the certain set of video macro blocks comprises four video macro blocks of 16×16 classification mode and prediction directions of four video macro blocks of 16×16 classification mode are different.

Particularly, after the determination of 4×4 classification mode, the rest of video macro blocks are 16×16 classification mode, wherein when a certain set of video macro blocks includes four video macro blocks of 16×16 classification mode, this certain set of video macro blocks will have four prediction directions, {0,1,2,3}, and if difference exists in prediction directions of a certain set of video macro blocks, CU of the H.265 CTU corresponding to 4 video macro blocks of 16×16 classification mode will be ascertained to be 16×16 mode. For example, referring to FIG. 5, CU corresponding to video macro blocks in the third set {8,9,12,13} is ascertained to be 16×16 mode.

S206: ascertaining that CU of the H.265 CTU corresponding to each video macro block in the N sets of video macro blocks is 32×32 mode as N is smaller than 4, and ascertaining that CU of the H.265 CTU corresponding to each video macro block in the N sets of video macro blocks is 64×64 mode as N is equal to 4, when each of N sets of video macro blocks comprises four video macro blocks of 16×16 classification mode, prediction directions of which are the same.

Particularly, if each of the four sets of video macro blocks includes 4 video macro blocks of 16×16 classification mode and prediction directions of four video macro blocks of 16×16 classification mode in each of the four sets of video macro blocks are the same, CUs of the H.265 CTU respectively corresponding to the four sets of video macro blocks will be ascertained to be 64×64 mode. If not every one of the four sets satisfies the above condition, CUs, respectively corresponding to video macro blocks in the set of video macro blocks that satisfies the condition where there are 4 video macro blocks of 16×16 classification mode whose prediction directions are the same, will be ascertained to be 32×32 mode. For example, referring to FIG. 5, CU corresponding to each video macro block in the first set {0, 1, 4, 5}, the second set {2, 3, 6, 7} is ascertained to be 32×32 mode.

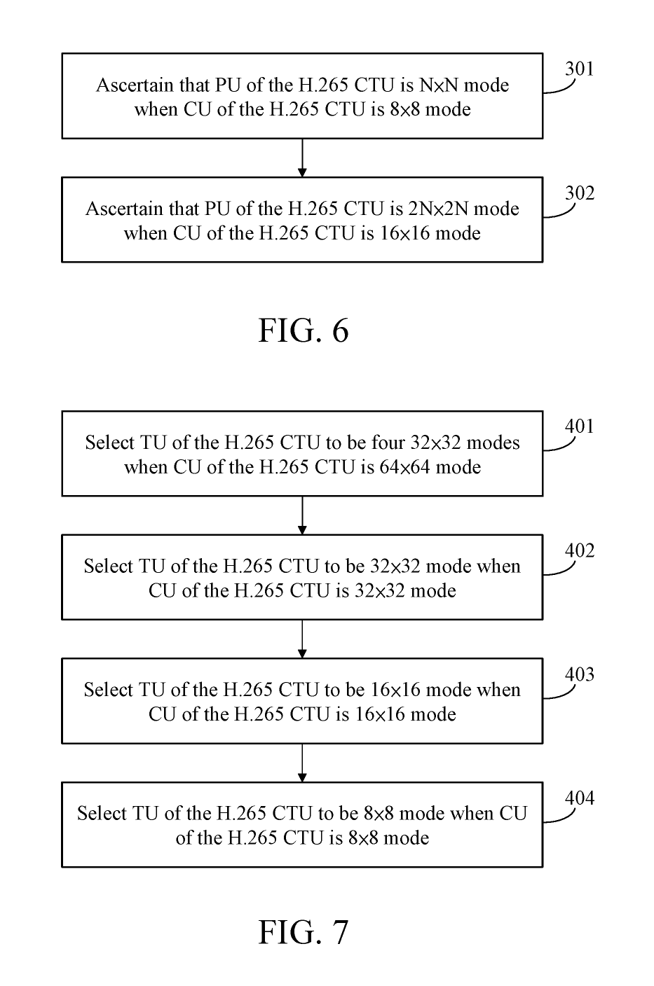

Particularly, referring to FIG. 6, in S103b, ascertaining PU of the H.265 CTU according to the ascertained CU of the H.265 CTU and preset intra prediction unit PU ascertainment relationship includes:

S301: ascertaining that PU of the H.265 CTU is N×N mode when CU of the H.265 CTU is 8×8 mode, wherein prediction direction of PU of the H.265 CTU is mode H.265 26 if intra-frame prediction direction of the H.264 video macro block is mode H.264 0, prediction direction of PU of the H.265 CTU is mode H.265 10 if intra-frame prediction direction of the H.264 video macro block is mode H.264 1, prediction direction of PU of the H.264 video macro block is selected from the best one of mode H.265 0 and mode H.265 1 if intra-frame prediction direction of the H.264 video macro block is mode H.264 2, prediction direction of PU of the H.264 video macro block is selected from the best one of mode H.265 31, mode H.265 32 and mode H.265 33 if intra-frame prediction direction of the H.264 video macro block is mode H.264 3, prediction direction of PU of the H.264 video macro block is selected from the best one of mode H.265 17, mode H.265 18 and mode H.265 19 if intra-frame prediction direction of the H.264 video macro block is mode H.264 4, prediction direction of PU of the H.264 video macro block is selected from the best one of mode H.265 22, mode H.265 23 and mode H.265 24 if intra-frame prediction direction of the H.264 video macro block is mode H.264 5, prediction direction of PU of the H.264 video macro block is selected from the best one of mode H.265 12, mode H.265 13 and mode H.265 14 if intra-frame prediction direction of the H.264 video macro block is mode H.264 6, prediction direction of PU of the H.264 video macro block is selected from the best one of mode H.265 28, mode H.265 29 and mode H.265 30 if intra-frame prediction direction of the H.264 video macro block is mode H.264 7, and prediction direction of PU of the H.264 video macro block is selected from the best one of mode H.265 3, mode H.265 4, mode H.265 5 and mode H.265 6 if intra-frame prediction direction of the H.264 video macro block is mode H.264 8.

Particularly, 4×4 classification mode of H.264 video macro blocks totally has 9 intra-frame prediction direction modes, which respectively expressed as H.264 0, H.264 1, H.264 2, H.264 3, H.264 4, H.264 5, H.264 6, H.264 7, H.264 8.

Particularly, in H.265, intra-frame predictions of brightness encoding blocks further extend to have include 35 prediction modes, including 0 (Planar mode), 1 (DC mode) and 33 direction modes (2-34).

Particularly, selecting the best one of mode H.265 0 and mode H.265 1 can be implemented in any possible way, which has some limitation herein that, for example, selection can be made by a rate-distortion cost manner for calculating prediction direction modes. The selection of other best things is made by a similar manner, and there are no more related descriptions hereafter.

S302: ascertaining that predict unit (PU) of the H.265 CTU is 2N×2N mode when CU of the H.265 CTU is 16×16 mode, 32×32 mode or 64×64 mode, wherein prediction direction of PU of the H.264 video macro block is mode H.265 26 if intra-frame prediction direction of the H.264 video macro block is mode H.264 0, prediction direction of PU of the H.264 video macro block is mode H.265 10 if intra-frame prediction direction of the H.264 video macro block is mode H.264 1, prediction direction of PU of the H.264 video macro block is mode H.265 0 if intra-frame prediction direction of the H.264 video macro block is mode H.264 2, and prediction direction of PU of the H.264 video macro block is mode H.265 1 if intra-frame prediction direction of the H.264 video macro block is mode H.264 3.

Particularly, 16×16 classification mode of H.264 video macro blocks totally has 4 intra-frame prediction direction modes, respectively H.264 0, H.264 1, H.264 2, and H.264 3.

Particularly, referring to FIG. 7, in S103c, ascertaining TU of the H.265 CTU according to the ascertained CU of the H.265 CTU and preset TU ascertainment relationship includes:

S401: selecting TU of the H.265 CTU to be four 32×32 modes when CU of the H.265 CTU is 64×64 mod.

S402: selecting TU of the H.265 CTU to be 32×32 mode when CU of the H.265 CTU is 32×32 mode.

S403: selecting TU of the H.265 CTU to be 16×16 mode when CU of the H.265 CTU is 16×16 mode.

S404: selecting TU of the H.265 CTU to be 8×8 mode when CU of the H.265 CTU is 8×8 mode.

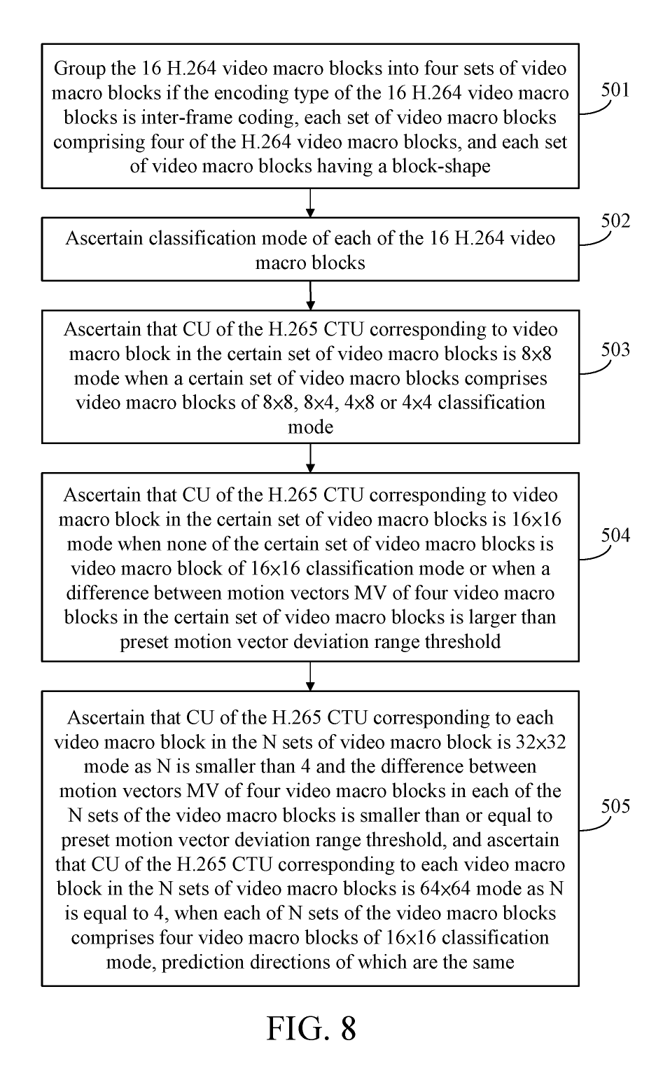

Particularly, referring to FIG. 8, in S104a, if the encoding type of the 16 H.264 video macro blocks is inter-frame coding, ascertaining CU of the H.265 CTU according to preset inter-frame coding unit CU ascertainment relationship includes:

S501: grouping the 16 H.264 video macro blocks into four sets of video macro blocks if encoding type of the 16 H.264 video macro blocks is inter-frame coding, each set of video macro block including four H.264 video macro blocks, and shape of each set of video macro blocks is square.

Particularly, a H.264 video macro block on inter-frame coding has a variety of classification modes: one 16×16 sub-block, two 16×8 sub-blocks, two 8×16 sub-blocks, or four 8×8 sub-blocks. Each 8×8 sub-block can further be divided into: one 8×8 sub-block, two 8×4 sub-blocks, two 4×8 sub-blocks, or four 4×4 sub-blocks.

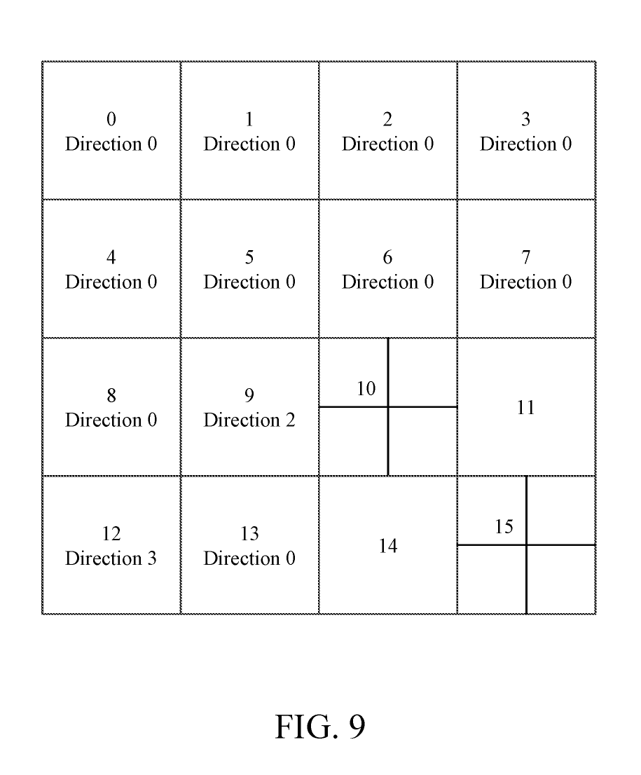

Particularly, referring to FIG. 9, 16 H.264 video macro blocks (0, 1, 2, 3, 4, 5, 6, 7, 8, 9, 10, 11, 12, 13, 14, 15) are grouped into four sets of video macro blocks including: {0, 1, 4, 5}, {2, 3, 6, 7}, {8, 9, 12, 13}, {10, 11, 14, 15}.

S502: ascertaining classification mode of each of the 16 H.264 video macro blocks.

S503: ascertaining that CU of the H.265 CTU corresponding to video macro block in the certain set of video macro blocks is 8×8 mode when a certain set of video macro blocks comprises video macro blocks of 8×8, 8×4, 4×8 or 4×4 classification mode.

For example, assume 10, 15 have less than 8×8 classification mode, and thus, CU corresponding to video macro blocks in the fourth set {10, 11, 14, 15} is ascertained to be 8×8 mode.

S504: ascertaining that CU of the H.265 CTU corresponding to video macro block in the certain set of video macro blocks is 16×16 mode when none of the certain set of video macro blocks is video macro block of 16×16 classification mode or when a difference between motion vectors MV of four video macro blocks in the certain set of video macro blocks is larger than preset motion vector deviation range threshold.

Particularly, preset motion vector deviation range threshold is set as (−2, 2).

For example, assume 8 is 16×8 classification mode, and thus, CU corresponding to video macro blocks in the third set {8, 9, 12, 13} is ascertained to be 16×16 mode.

S505: ascertaining that CU of the H.265 CTU corresponding to each video macro block in the N sets of video macro block is 32×32 mode as N is smaller than 4 and the difference between motion vectors MV of four video macro blocks in each of the N sets of the video macro blocks is smaller than or equal to preset motion vector deviation range threshold, and ascertaining that CU of the H.265 CTU corresponding to each video macro block in the N sets of video macro blocks is 64×64 mode as N is equal to 4, when each of N sets of the video macro blocks comprises four video macro blocks of 16×16 classification mode, prediction directions of which are the same.

Particularly, if each of the four sets of video macro blocks includes 4 video macro blocks of 16×16 classification mode and prediction directions of 4 video macro blocks of 16×16 classification mode in each of the four sets of video macro blocks are the same, CU of H.265 CTU corresponding to each video macro block in the four sets of video macro blocks is ascertained to be 64×64 mode.

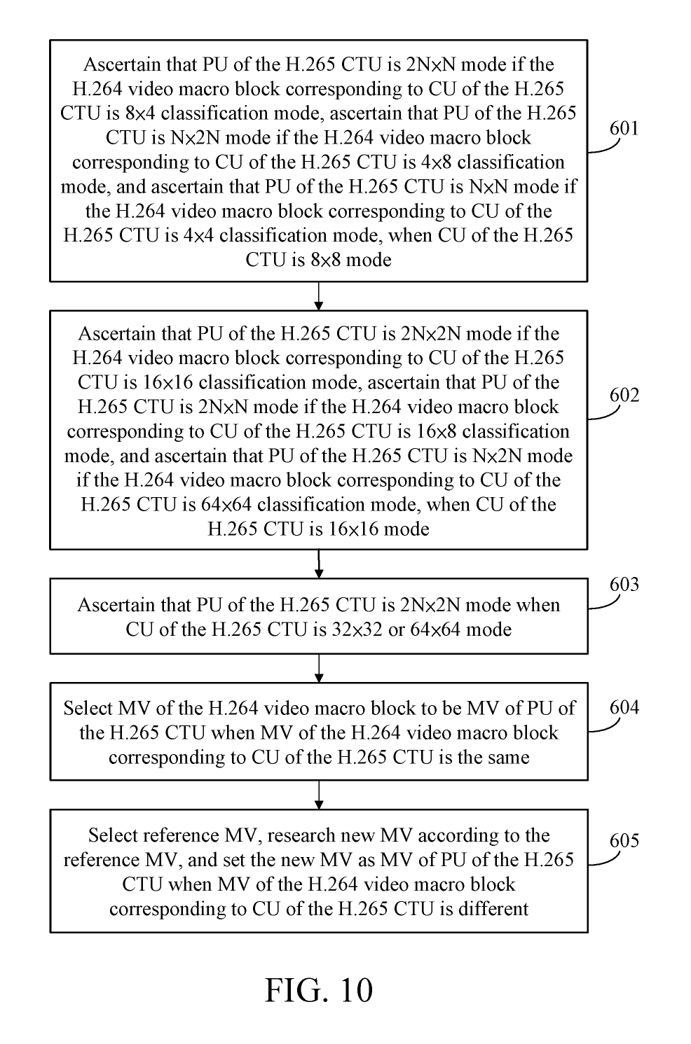

Particularly, referring to FIG. 10, in S104b, ascertaining PU of the H.265 CTU according to the ascertained CU of the H.265 CTU and preset inter-frame PU ascertainment relationship includes:

S601: ascertaining that PU of the H.265 CTU is 2N×N mode if the H.264 video macro block corresponding to CU of the H.265 CTU is 8×4 classification mode, ascertaining that PU of the H.265 CTU is N×2N mode if the H.264 video macro block corresponding to CU of the H.265 CTU is 4×8 classification mode, and ascertaining that PU of the H.265 CTU is N×N mode if the H.264 video macro block corresponding to CU of the H.265 CTU is 4×4 classification mode, when CU of the H.265 CTU is 8×8 mode.

Particularly, H.265 inter-frame prediction totally supports 8 prediction modes including: PART_2N×2N,PART_2N×N, PART_{—N×}2N, PART_2N×nU, PART_2N×nD, PART_nL×2N,PART_nR×2N, PART_N×N. Under PART_2N×N, PART_N×2N modes, CB block is divided into two PB blocks with the same size in a horizontal or vertical direction.

Under PART_2N×nU, PART_2N×nD, PART_nL×2N, PART_nR×2N modes, CB block is divided into two PB blocks with different sizes, and such a classification mode is referred to as asymmetric motion partitions (AMP) classification mode, which is an inter-frame prediction mode newly introduced by H.265. The PART_N×N mode of inter-frame has the same usage condition with the PART_N×N mode of intra-frame.

S602: ascertaining that PU of the H.265 CTU is 2N×2N mode if the H.264 video macro block corresponding to CU of the H.265 CTU is 16×16 classification mode, ascertaining that PU of the H.265 CTU is 2N×N mode if the H.264 video macro block corresponding to CU of the H.265 CTU is 16×8 classification mode, and ascertaining that PU of the H.265 CTU is N×2N mode if the H.264 video macro block corresponding to CU of the H.265 CTU is 64×64 classification mode, when CU of the H.265 CTU is 16×16 mode.

S603: ascertaining that PU of the H.265 CTU is 2N×2N mode when CU of the H.265 CTU is 32×32 or 64×64 mode.

S604: selecting MV of the H.264 video macro block to be MV of PU of the H.265 CTU when MV of the H.264 video macro block corresponding to CU of the H.265 CTU is the same.

S605: selecting reference MV, researching new MV according to the reference MV, and setting the new MV as MV of PU of the H.265 CTU when MV of the H.264 video macro block corresponding to CU of the H.265 CTU is different.

Particularly, selecting the reference MV can be made by selecting the intermediate value of the MVs as a reference MV. When the number of different MVs is even, it can be made to downwardly select smaller intermediate one of the MVs as a reference MV. On the basis of the reference MV, searching for a new MV is made within a preset window region (e.g. 2×2 window).

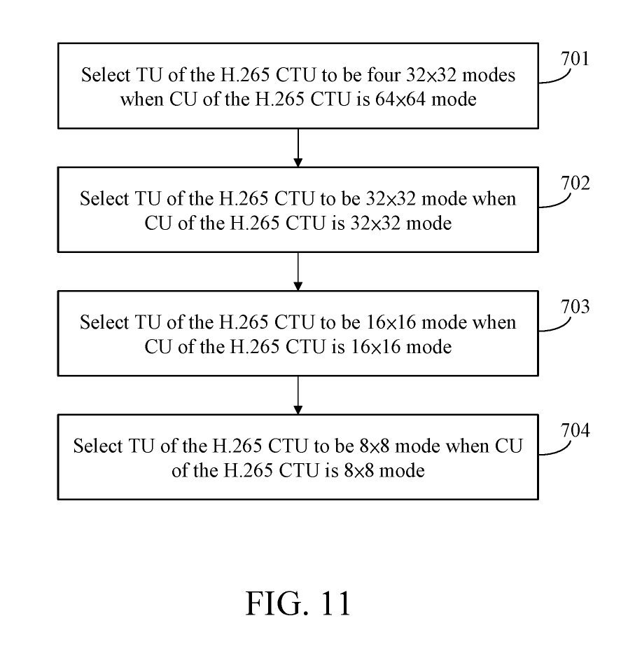

Particularly, referring to FIG. 11, in S104c, ascertaining TU of the H.265 CTU according to the ascertained CU of the H.265 CTU and preset transformation unit TU ascertainment relationship includes:

S701: selecting TU of the H.265 CTU to be four 32×32 modes when CU of the H.265 CTU is 64×64 mode.

S702: selecting TU of the H.265 CTU to be 32×32 mode when CU of the H.265 CTU is 32×32 mode.

S703: selecting TU of the H.265 CTU to be 16×16 mode when CU of the H.265 CTU is 16×16 mode.

S704: selecting TU of the H.265 CTU to be 8×8 mode when CU of the H.265 CTU is 8×8 mode.

In the transcoding method described in embodiments of the present invention, if encoding type of 16 H.264 video macro blocks is intra-frame coding, the 16 H.264 video macro blocks are transcoded into a H.265 coding tree unit CTU according to preset intra-frame transcoding correspondence; if encoding type of 16 H.264 video macro blocks is inter-frame coding, the 16 H.264 video macro blocks are transcoded into a H.265 coding tree unit CTU according to preset inter-frame transcoding correspondence; and since it is necessary to decode H.264 video macro blocks to produce original video data, the transcoding process can speed up and save time. To ascertain CU of the H.265 CTU according to preset intra-frame CU ascertainment relationship, ascertain PU of the H.265 CTU according to preset intra prediction unit PU ascertainment relationship, and ascertain TU of the H.265 CTU according to preset transformation unit TU ascertainment relationship can fast implement transcoding H.264 video macro blocks into a H.265 coding tree unit CTU during intra-frame coding. To ascertain CU of the H.265 CTU according to preset inter-frame CU ascertainment relationship, ascertain PU of the H.265 CTU according to preset inter-frame prediction unit PU ascertainment relationship, and ascertain TU of the H.265 CTU according to preset transformation unit TU ascertainment relationship can fast implement transcoding H.264 video macro blocks into a H.265 coding tree unit CTU during inter-frame coding.

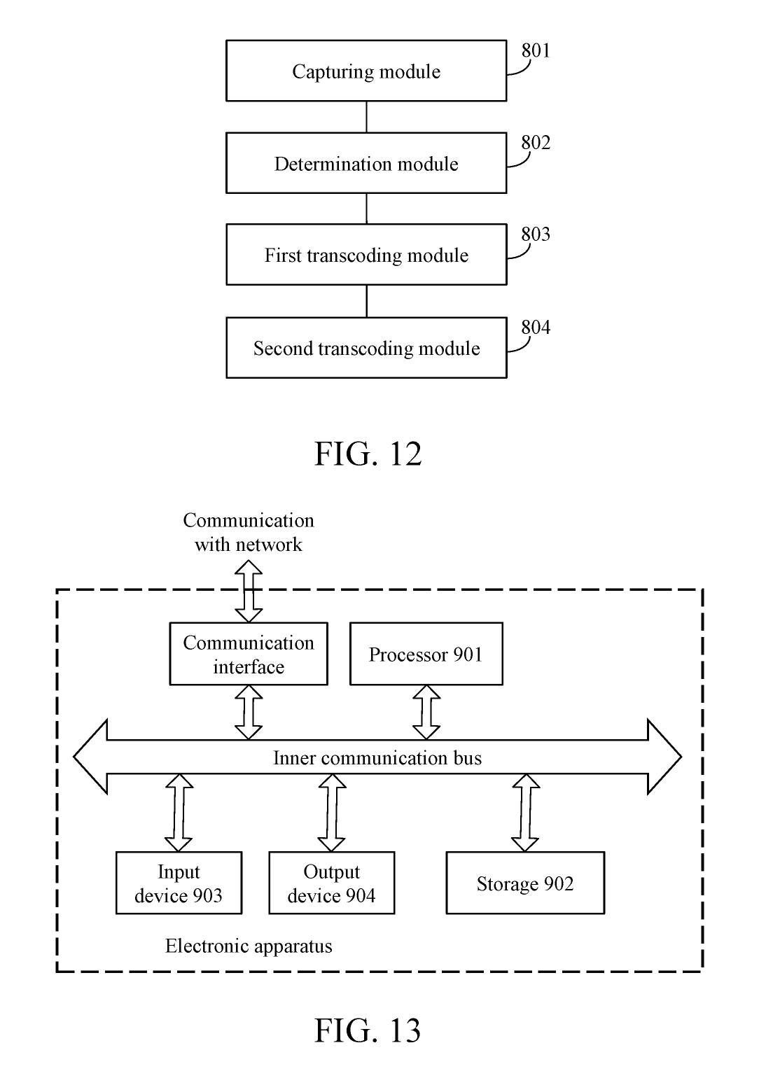

FIG. 12 illustrates a transcoding device provided in an embodiment of the present invention, which includes:
capturing module 801 configured to capture 16 H.264 video macro blocks;
determination module 802 configured to determine encoding type of the 16 H.264 video macro blocks;
first transcoding module 803 configured to transcode the 16 H.264 video macro blocks into a H.265 coding tree unit CTU according to preset intra-frame transcoding correspondence if the encoding type of the 16 H.264 video macro blocks is intra-frame coding;
second transcoding module 804 configured to transcode the 16 H.264 video macro blocks into a H.265 CTU according to preset inter-frame transcoding correspondence if the encoding type of the 16 H.264 video macro blocks is inter-frame coding.

Optionally, the first transcoding module 803 includes:
first CU ascertaining unit configured to ascertain CU of the H.265 CTU according to preset intra-frame coding unit CU ascertainment relationship if the encoding type of the 16 H.264 video macro blocks is intra-frame coding;
first PU ascertaining unit configured to ascertain PU of the H.265 CTU according to the ascertained CU of the H.265 CTU and preset intra prediction unit PU ascertainment relationship;
first TU ascertaining unit configured to ascertain TU of the H.265 CTU according to the ascertained CU of the H.265 CTU and preset transformation unit TU ascertainment relationship.

Optionally, the first CU ascertaining unit includes:
first classification mode ascertaining sub-unit configured to ascertain classification mode of each of the 16 H.264 video macro blocks if the encoding type of the 16 H.264 video macro blocks is intra-frame coding;
first 8×8 mode CU ascertaining sub-unit configured to ascertain that CU of the H.265 CTU corresponding to the certain first video macro block is 8×8 mode when classification mode of a certain first video macro block is 4×4;
first classification sub-unit configured to group the 16 H.264 video macro blocks into four sets of video macro blocks, each set of video macro blocks including four of the H.264 video macro blocks, and shape of each set of video macro blocks is square;
first 16×16 mode CU ascertaining sub-unit configured to ascertain that CU of the H.265 CTU corresponding to the certain set of video macro blocks except the first video macro block is 16×16 mode when a certain set of video macro blocks comprises first video macro blocks of 4×4 classification mode;
second 16×16 mode CU ascertaining sub-unit configured to ascertain that CU of the H.265 CTU corresponding to four video macro blocks of 16×16 classification mode is 16×16 mode when the certain set of video macro blocks comprises four video macro blocks of 16×16 classification mode and prediction directions of four video macro blocks of 16×16 classification mode are different;
first 32-and-64-mode CU ascertaining sub-unit configured to ascertain that CU of the H.265 CTU corresponding to each video macro block in the N sets of video macro blocks is 32×32 mode as N is smaller than 4, and to ascertain that CU of the H.265 CTU corresponding to each video macro block in the N sets of video macro blocks is 64×64 mode as N is equal to 4, when each of N sets of video macro blocks comprises four video macro blocks of 16×16 classification mode and prediction directions of four video macro blocks of 16×16 classification mode in each of the N sets of video macro blocks are the same.

Optionally, the first PU ascertaining unit includes:
first PU ascertaining sub-unit configured to ascertain that PU of the H.265 CTU is N×N mode when CU of the H.265 CTU is 8×8 mode, wherein prediction direction of PU of the H.264 video macro block is mode H.265 26 if intra-frame prediction direction of the H.264 video macro block is mode H.264 0, prediction direction of PU of the H.264 video macro block is mode H.265 10 if intra-frame prediction direction of the H.264 video macro block is mode H.264 1, prediction direction of PU of the H.264 video macro block is selected from the best one of mode H.265 0 and mode H.265 1 if intra-frame prediction direction of the H.264 video macro block is mode H.264 2, prediction direction of PU of the H.264 video macro block is selected from the best one of mode H.265 31, mode H.265 32 and mode H.265 33 if intra-frame prediction direction of the H.264 video macro block is mode H.264 3, prediction direction of PU of the H.264 video macro block is selected from the best one of mode H.265 17, mode H.265 18 and mode H.265 19 if intra-frame prediction direction of the H.264 video macro block is mode H.264 4, prediction direction of PU of the H.264 video macro block is selected from the best one of mode H.265 22, mode H.265 23 and mode H.265 24 if intra-frame prediction direction of the H.264 video macro block is mode H.264 5, prediction direction of PU of the H.264 video macro block is selected from the best one of mode H.265 12, mode H.265 13 and mode H.265 14 if intra-frame prediction direction of the H.264 video macro block is mode H.264 6, prediction direction of PU of the H.264 video macro block is selected from the best one of mode H.265 28, mode H.265 29 and mode H.265 30 if intra-frame prediction direction of the H.264 video macro block is mode H.264 7, and prediction direction of PU of the H.264 video macro block is selected from the best one of mode H.265 3, mode H.265 4, mode H.265 5 and mode H.265 6 if intra-frame prediction direction of the H.264 video macro block is mode H.264 8;

second PU ascertaining sub-unit configured to ascertain that PU of the H.265 CTU is 2N×2N mode when CU of the H.265 CTU is 16×16 mode, 32×32 mode or 64×64 mode, wherein prediction direction of PU of the H.264 video macro block is mode H.265 26 if intra-frame prediction direction of the H.264 video macro block is mode H.264 0, prediction direction of PU of the H.264 video macro block is mode H.265 10 if intra-frame prediction direction of the H.264 video macro block is mode H.264 1, prediction direction of PU of the H.264 video macro block is mode H.265 0 if intra-frame prediction direction of the H.264 video macro block is mode H.264 2, and prediction direction of PU of the H.264 video macro block is mode H.265 1 if intra-frame prediction direction of the H.264 video macro block is mode H.264 3.

Optionally, the first TU ascertaining unit includes:
first 32×32 mode TU ascertaining sub-unit configured to select TU of the H.265 CTU to be four 32×32 modes when CU of the H.265 CTU is 64×64 mode;
second 32×32 mode TU ascertaining sub-unit configured to select TU of the H.265 CTU to be 32×32 mode when CU of the H.265 CTU is 32×32 mode;
first 16×16 mode TU ascertaining sub-unit configured to select TU of the H.265 CTU to be 16×16 mode when CU of the H.265 CTU is 16×16 mode;
first 8×8 mode TU ascertaining sub-unit configured to select TU of the H.265 CTU to be 8×8 mode when CU of the H.265 CTU is 8×8 mode.

Optionally, the second transcoding module 804 includes:
second CU ascertaining unit configured to ascertain CU of the H.265 CTU according to preset inter-frame coding unit CU ascertainment relationship if the encoding type of the 16 H.264 video macro blocks is inter-frame coding;
second PU ascertaining unit configured to ascertain PU of the H.265 CTU according to the ascertained CU of the H.265 CTU and preset inter-frame PU ascertainment relationship;
second TU ascertaining unit configured to ascertain TU of the H.265 CTU according to the ascertained CU of the H.265 CTU and preset transformation unit TU ascertainment relationship.

Optionally, the second CU ascertaining unit includes:
second classification sub-unit configured to group the 16 H.264 video macro blocks into four sets of video macro blocks if the encoding type of the 16 H.264 video macro blocks is inter-frame coding, each set of video macro blocks including four of the H.264 video macro blocks, and shape of each set of video macro blocks is square;
second classification mode ascertaining sub-unit configured to ascertain classification mode of each of the 16 H.264 video macro blocks;
second 8×8 mode CU ascertaining sub-unit configured to ascertain that CU of the H.265 CTU corresponding to video macro block in a certain set of video macro blocks is 8×8 mode when the certain set of video macro blocks comprises video macro blocks of 8×8, 8×4, 4×8 or 4×4 classification mode;
third 16×16 mode CU ascertaining sub-unit configured to ascertain that CU of the H.265 CTU corresponding to video macro blocks in the certain set of video macro blocks is 16×16 mode when none of the certain set of video macro blocks is video macro block of 16×16 classification mode or when a difference between motion vectors MV of four video macro blocks in the certain set of video macro blocks is larger than preset motion vector deviation range threshold;
second 32-and-64-mode ascertaining sub-unit configured to ascertain that CU of the H.265 CTU corresponding to each video macro block in the N sets of video macro blocks is 32×32 mode as N is smaller than 4 and the difference between motion vectors

MV of four video macro blocks in each of the N sets of video macro blocks is smaller than or equal to preset motion vector deviation range threshold, and to ascertain that CU of the H.265 CTU corresponding to each video macro block in the N sets of video macro blocks is 64×64 mode as N is equal to 4, when each of the N sets of video macro block comprises four video macro blocks of 16×16 classification mode and prediction directions of four video macro blocks of 16×16 classification mode in each of the N sets of video macro blocks are the same.

Optionally, the second PU ascertaining unit includes:
third PU ascertaining sub-unit configured to ascertain that PU of the H.265 CTU is 2N×N mode if the H.264 video macro block corresponding to CU of the H.265 CTU is 8×4 classification mode, ascertain that PU of the H.265 CTU is N×2N mode if the H.264 video macro block corresponding to CU of the H.265 CTU is 4×8 classification mode, and ascertain that PU of the H.265 CTU is N×N mode if the H.264 video macro block corresponding to CU of the H.265 CTU is 4×4 classification mode, when CU of the H.265 CTU is 8×8 mode;
fourth PU ascertaining sub-unit configured to ascertain that PU of the H.265 CTU is 2N×2N mode if the H.264 video macro block corresponding to CU of the H.265 CTU is 16×16 classification mode, ascertain that PU of the H.265 CTU is 2N×N mode if the H.264 video macro block corresponding to CU of the H.265 CTU is 16×8 classification mode, and ascertain that PU of the H.265 CTU is N×2N mode if the H.264 video macro block corresponding to CU of the H.265 CTU is 64×64 classification mode, when CU of the H.265 CTU is 16×16 mode;
fifth PU ascertaining sub-unit configured to ascertain that PU of the H.265 CTU is 2N×2N mode when CU of the H.265 CTU is 32×32 or 64×64 mode;
first MV ascertaining sub-unit configured to select MV of the H.264 video macro block as MV of PU of the H.265 CTU when MV of the H.264 video macro block corresponding to CU of the H.265 CTU is the same;
second MV ascertaining sub-unit configured to select reference MV, research new MV according to the reference MV, and set the new MV as MV of PU of the H.265 CTU when MV of the H.264 video macro block corresponding to CU of the H.265 CTU is different.

Optionally, the second TU ascertaining unit includes:
third 32×32 mode TU ascertaining sub-unit configured to select TU of the H.265 CTU to be four 32×32 modes when CU of the H.265 CTU is 64×64 mode;
fourth 32×32 mode TU ascertaining sub-unit configured to select TU of the H.265 CTU to be 32×32 mode when CU of the H.265 CTU is 32×32 mode;
second 16×16 mode TU ascertaining sub-unit configured to select TU of the H.265 CTU to be 16×16 mode when CU of the H.265 CTU is 16×16 mode;
second 8×8 mode TU ascertaining sub-unit configured to select TU of the H.265 CTU to be 8×8 mode when CU of the H.265 CTU is 8×8 mode.

In the transcoding device illustrated in embodiments of the present invention, if encoding type of 16 H.264 video macro blocks is intra-frame coding, the 16 H.264 video macro blocks are transcoded into a H.265 coding tree unit CTU according to preset intra-frame transcoding correspondence; if encoding type of 16 H.264 video macro blocks is inter-frame coding, the 16 H.264 video macro blocks are transcoded into a H.265 coding tree unit CTU according to preset inter-frame transcoding correspondence; and since it is necessary to decode H.264 video macro blocks to produce original video data, the transcoding process can speed up and save time. To ascertain CU of the H.265 CTU according to preset intra-frame CU ascertainment relationship, ascertain PU of the H.265 CTU according to preset intra prediction unit PU ascertainment relationship, and ascertain TU of the H.265 CTU according to preset transformation unit TU ascertainment relationship can fast implement transcoding H.264 video macro blocks into a H.265 coding tree unit CTU during intra-frame coding. To ascertain CU of the H.265 CTU according to preset inter-frame CU ascertainment relationship, ascertain PU of the H.265 CTU according to preset inter-frame prediction unit PU ascertainment relationship, and ascertain TU of the H.265 CTU according to preset transformation unit TU ascertainment relationship can fast implement transcoding H.264 video macro blocks into a H.265 coding tree unit CTU during inter-frame coding.

The described apparatus embodiment is merely exemplary. The units described as separate parts may or may not be physically separate, and parts displayed as units may or may not be physical units, that is, may be located in one position, or may be distributed on a plurality of network units. A part or all of the modules may be selected according to actual needs to achieve the objectives of the solutions of the embodiments. A person of ordinary skill in the art may understand and implement the technical solution without creative works.

An embodiment of the application further provides a non-volatile computer storage medium storing computer-executable instructions executed to perform the transcoding method in any of the above method embodiments.

FIG. 13 illustrates an electronic apparatus of transcoding provided in an embodiment of the application, and the apparatus includes:
one or more processors 901 and storages 902, and in FIG. 6, one processor 901 is included exemplarily.

The electronic apparatus performing the transcoding method can further include: input device 903 and output device 904.

The processor 901, the storage 902, the input device 903 and the output device 904 can be connected via buses or other manners, and in FIG. 13, they are exemplarily connected via a bus.

The storage 902 as a non-volatile computer-readable storage medium can store non-volatile software programs, non-volatile computer-executable programs and modules. The processor 901 executes function applications and data processing of the server, i.e. the transcoding method in the method embodiments, by running the non-volatile software programs, non-volatile computer-executable programs and modules stored in the storage 902.

The storage 902 can include a program storage area and a data storage area, wherein the program storage area can store an operating system and at least one application program required for a function; the data storage area can store the data created according to the use of a processing device of video transcoding. Furthermore, the storage 902 can include a high speed random-access memory, and further include a non-volatile memory such as at least one disk storage member, at least one flash memory member and other non-volatile solid state storage member. In some embodiments, the storage 902 can be selected from memories having a remote connection with the processor 901, and these remote memories can be connected to a processing device of video transcoding by a network. The aforementioned network includes, but not limited to, internet, intranet, local area network, mobile communication network and combination thereof.

The input device 903 can receive digital or character information and generate a key signal input corresponding to the user setting and the function control of the transcoding device. The output device 904 can include a display apparatus such as a screen.

The one or more modules are stored in the storage 902, and the one or more modules execute the transcoding method in any of the above embodiments when executed by the one or more processors 901.

The aforementioned product can execute the method in the embodiments of the application, and has functional modules and beneficial effect corresponding to the execution of the method. The technical details not described in the embodiments can be referred to the method provided in the embodiments of the application.

The electronic apparatus in the embodiments of the present application is presence in many forms, and the electronic apparatus includes, but not limited to:
(1) mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.
(2) ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.
(3) portable entertainment apparatus: this type of apparatus can display and play multimedia contents. This type of apparatus includes: audio, video player (e.g. iPod), handheld game console, e-books, as well as smart toys and portable vehicle-mounted navigation apparatus.
(4) server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.
(5) other electronic apparatus having a data exchange function.

The technical solutions and the functional feature and connection of each module in the apparatus correspond to the features and technical solutions described in the embodiments of FIG. 1˜FIG. 11, and insufficient parts can be referred to the above embodiments of FIG. 1˜FIG. 11.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions recorded in the foregoing embodiments or make equivalent replacements to part of technical features of the technical solutions recorded in the foregoing embodiments; however, these modifications or replacements do not make the essence of the corresponding technical solutions depart from the spirit and scope of the technical solutions of the embodiments of the present invention.

What is claimed is:

1. A transcoding method, applied to a terminal and comprising:
obtaining 16 H.264 video macro blocks;
determining encoding type of the 16 H.264 video macro blocks;
transcoding the 16 H.264 video macro blocks into a H.265 coding tree unit (CTU) according to preset intra-frame transcoding correspondence if the encoding type of the 16 H.264 video macro blocks is intra-frame coding;
transcoding the 16 H.264 video macro blocks into one H.265 CTU according to preset inter-frame transcoding correspondence if the encoding type of the 16 H.264 video macro blocks is inter-frame coding.

2. The method according to claim 1, wherein if the encoding type of the 16 H.264 video macro blocks is intra-frame coding, transcoding the 16 H.264 video macro blocks into a H.265 CTU according to preset intra-frame transcoding correspondence comprises:
ascertaining CU of the H.265 CTU according to preset intra-frame coding unit CU ascertainment relationship if the encoding type of the 16 H.264 video macro blocks is intra-frame coding;
ascertaining PU of the H.265 CTU according to the ascertained CU of the H.265 CTU and preset intra prediction unit PU ascertainment relationship;
ascertaining TU of the H.265 CTU according to the ascertained CU of the H.265 CTU and preset transformation unit TU ascertainment relationship.

3. The method according to claim 2, wherein if the encoding type of the 16 H.264 video macro blocks is intra-frame coding, ascertaining CU of the H.265 CTU according to preset intra-frame coding unit CU ascertainment relationship comprises:
ascertaining classification mode of each of the 16 H.264 video macro blocks if the encoding type of the 16 H.264 video macro blocks is intra-frame coding;
ascertaining that CU of the H.265 CTU corresponding to a certain first video macro block is 8×8 mode if classification mode of the certain first video macro block is 4×4;
grouping the 16 H.264 video macro blocks into four sets of video macro blocks, each set of video macro blocks comprising four of the H.264 video macro blocks, and shape of each set of video macro blocks is square;
ascertaining that CU of the H.265 CTU corresponding to a certain set of video macro blocks except the first video macro block is 16×16 mode if the certain set of video macro blocks comprises first video macro blocks of 4×4 classification mode;
ascertaining that CU of the H.265 CTU corresponding to four video macro blocks of 16×16 classification mode is 16×16 mode if the certain set of video macro blocks comprises four video macro blocks of 16×16 classification mode, prediction directions of which are different;
ascertaining that CU of the H.265 CTU corresponding to each video macro block in the N sets of video macro blocks is 32×32 mode as N is smaller than 4, and ascertaining that CU of the H.265 CTU corresponding to each video macro block in the N sets of video macro blocks is 64×64 mode as N is equal to 4, if each of N sets of video macro blocks comprises four video macro blocks of 16×16 classification mode, prediction directions of which are the same.

4. The method according to claim 3, wherein ascertaining PU of the H.265 CTU according to the ascertained CU of the H.265 CTU and preset intra prediction unit PU ascertainment relationship comprises:
ascertaining that PU of the H.265 CTU is N×N mode if CU of the H.265 CTU is 8×8 mode, wherein prediction direction of PU of the H.265 CTU is mode H.265 26 if intra-frame prediction direction of the H.264 video macro block is mode H.264 0, prediction direction of PU of the H.265 CTU is mode H.265 10 if intra-frame prediction direction of the H.264 video macro block is mode H.264 1, prediction direction of PU of the H.264 video macro block is selected from the best one of mode H.265 0 and mode H.265 1 if intra-frame prediction direction of the H.264 video macro block is mode H.264 2, prediction direction of PU of the H.264 video macro block is selected from the best one of mode H.265 31, mode H.265 32 and mode H.265 33 if intra-frame prediction direction of the H.264 video macro block is mode H.264 3, prediction direction of PU of the H.264 video macro block is selected from the best one of mode H.265 17, mode H.265 18 and mode H.265 19 if intra-frame prediction direction of the H.264 video macro block is mode H.264 4, prediction direction of PU of the H.264 video macro block is selected from the best one of mode H.265 22, mode H.265 23 and mode H.265 24 if intra-frame prediction direction of the H.264 video macro block is mode H.264 5, prediction direction of PU of the H.264 video macro block is selected from the best one of mode H.265 12, mode H.265 13 and mode H.265 14 if intra-frame prediction direction of the H.264 video macro block is mode H.264 6, prediction direction of PU of the H.264 video macro block is selected from the best one of mode H.265 28, mode H.265 29 and mode H.265 30 if intra-frame prediction direction of the H.264 video macro block is mode H.264 7, and prediction direction of PU of the H.264 video macro block is selected from the best one of mode H.265 3, mode H.265 4, mode H.265 5 and mode H.265 6 if intra-frame prediction direction of the H.264 video macro block is mode H.264 8;
ascertaining that PU of the H.265 CTU is 2N×2N mode if CU of the H.265 CTU is 16×16 mode, 32×32 mode or 64×64 mode, wherein prediction direction of PU of the H.264 video macro block is mode H.265 26 if intra-frame prediction direction of the H.264 video macro block is mode H.264 0, prediction direction of PU of the H.264 video macro block is mode H.265 10 if intra-frame prediction direction of the H.264 video macro block is mode H.264 1, prediction direction of PU of the H.264 video macro block is mode H.265 0 if intra-frame prediction direction of the H.264 video macro block is mode H.264 2, and prediction direction of PU of the H.264 video macro block is mode H.265 1 if intra-frame prediction direction of the H.264 video macro block is mode H.264 3.

5. The method according to claim 3, wherein ascertaining TU of the H.265 CTU according to the ascertained CU of the H.265 CTU and preset transformation unit TU ascertainment relationship comprises:
selecting TU of the H.265 CTU to be four 32×32 modes if CU of the H.265 CTU is 64×64 mode;
selecting TU of the H.265 CTU to be 32×32 mode if CU of the H.265 CTU is 32×32 mode;
selecting TU of the H.265 CTU to be 16×16 mode if CU of the H.265 CTU is 16×16 mode;
selecting TU of the H.265 CTU to be 8×8 mode if CU of the H.265 CTU is 8×8 mode.

6. The method according to claim 1, wherein if the encoding type of the 16 H.264 video macro blocks is inter-frame coding, transcoding the 16 H.264 video macro blocks into one H.265 CTU according to preset inter-frame transcoding correspondence comprises:
ascertaining CU of the H.265 CTU according to preset inter-frame coding unit CU ascertainment relationship if the encoding type of the 16 H.264 video macro blocks is inter-frame coding;
ascertaining PU of the H.265 CTU according to the ascertained CU of the H.265 CTU and preset inter-frame PU ascertainment relationship;
ascertaining TU of the H.265 CTU according to the ascertained CU of the H.265 CTU and preset transformation unit TU ascertainment relationship.

7. The method according to claim 6, wherein if the encoding type of the 16 H.264 video macro blocks is inter-frame coding, ascertaining CU of the H.265 CTU according to preset inter-frame coding unit CU ascertainment relationship comprises:
if the encoding type of the 16 H.264 video macro blocks is inter-frame coding, grouping the 16 H.264 video macro blocks into four sets of video macro blocks, each set of video macro blocks comprising four of the H.264 video macro blocks, and shape of each set of video macro blocks is square;
ascertaining classification mode of each of the 16 H.264 video macro blocks;
ascertaining that CU of the H.265 CTU corresponding to video macro block in the certain set of video macro blocks is 8×8 mode if a certain set of video macro blocks comprises video macro blocks of 8×8, 8×4, 4×8 or 4×4 classification mode;
ascertaining that CU of the H.265 CTU corresponding to video macro block in the certain set of video macro blocks is 16×16 mode if none of the certain set of video macro blocks is video macro block of 16×16 classification mode or if a difference between motion vectors MV of four video macro blocks in the certain set of video macro blocks is larger than preset motion vector deviation range threshold;
if each of N sets of the video macro blocks comprises four video macro blocks of 16×16 classification mode, prediction directions of which are the same, ascertaining that CU of the H.265 CTU corresponding to each video macro block in the N sets of video macro block is 32×32 mode as N is smaller than 4 and the difference between motion vectors MV of four video macro blocks in each of the N sets of the video macro blocks is smaller than or equal to preset motion vector deviation range threshold, and ascertaining that CU of the H.265 CTU corresponding to each video macro block in the N sets of video macro blocks is 64×64 mode as N is equal to 4.

8. The method according to claim 7, wherein ascertaining PU of the H.265 CTU according to the ascertained CU of the H.265 CTU and preset inter-frame PU ascertainment relationship comprises:
if CU of the H.265 CTU is 8×8 mode, ascertaining that PU of the H.265 CTU is 2N×N mode if the H.264 video macro block corresponding to CU of the H.265 CTU is 8×4 classification mode, ascertaining that PU of the H.265 CTU is N×2N mode if the H.264 video macro block corresponding to CU of the H.265 CTU is 4×8 classification mode, and ascertaining that PU of the H.265 CTU is N×N mode if the H.264 video macro block corresponding to CU of the H.265 CTU is 4×4 classification mode;
if CU of the H.265 CTU is 16×16 mode, ascertaining that PU of the H.265 CTU is 2N×2N mode if the H.264 video macro block corresponding to CU of the H.265 CTU is 16×16 classification mode, ascertaining that PU of the H.265 CTU is 2N×N mode if the H.264 video macro block corresponding to CU of the H.265 CTU is 16×8 classification mode, and ascertaining that PU of the H.265 CTU is N×2N mode if the H.264 video macro block corresponding to CU of the H.265 CTU is 64×64 classification mode;
ascertaining that PU of the H.265 CTU is 2N×2N mode if CU of the H.265 CTU is 32×32 or 64×64 mode;
selecting MV of the H.264 video macro block to be MV of PU of the H.265 CTU if MV of the H.264 video macro block corresponding to CU of the H.265 CTU is the same;
selecting reference MV, researching new MV according to the reference MV, and setting the new MV as MV of PU of the H.265 CTU if MV of the H.264 video macro block corresponding to CU of the H.265 CTU is different.

9. The method according to claim 7, wherein ascertaining TU of the H.265 CTU according to the ascertained CU of the H.265 CTU and preset transformation unit TU ascertainment relationship comprises:
selecting TU of the H.265 CTU to be four 32×32 modes if CU of the H.265 CTU is 64×64 mode;
selecting TU of the H.265 CTU to be 32×32 mode if CU of the H.265 CTU is 32×32 mode;
selecting TU of the H.265 CTU to be 16×16 mode if CU of the H.265 CTU is 16×16 mode;
selecting TU of the H.265 CTU to be 8×8 mode if CU of the H.265 CTU is 8×8 mode.

10. A non-volatile computer storage medium storing computer-executable instructions configured to:
obtain 16 H.264 video macro blocks;
determine encoding type of the 16 H.264 video macro blocks;
transcode the 16 H.264 video macro blocks into a H.265 coding tree unit (CTU) according to preset intra-frame transcoding correspondence if the encoding type of the 16 H.264 video macro blocks is intra-frame coding;
transcode the 16 H.264 video macro blocks into one H.265 CTU according to preset inter-frame transcoding correspondence if the encoding type of the 16 H.264 video macro blocks is inter-frame coding.

11. An electronic apparatus of transcoding, comprising:
at least one processor; and, storage communicating with the at least one processor; wherein, the storage stores instructions executable by the at least one processor, and when executed by the at least one processor, the instructions causing the at least one processor to:
obtain 16 H.264 video macro blocks;
determine encoding type of the 16 H.264 video macro blocks;
transcode the 16 H.264 video macro blocks into a H.265 coding tree unit (CTU) according to preset intra-frame transcoding correspondence if the encoding type of the 16 H.264 video macro blocks is intra-frame coding;
transcode the 16 H.264 video macro blocks into one H.265 CTU according to preset inter-frame transcoding correspondence if the encoding type of the 16 H.264 video macro blocks is inter-frame coding.

12. The electronic apparatus according to claim 11, wherein, if the encoding type of the 16 H.264 video macro blocks is intra-frame coding, ascertaining CU of the H.265 CTU according to preset intra-frame coding unit CU ascertainment relationship comprises:
ascertaining classification mode of each of the 16 H.264 video macro blocks if the encoding type of the 16 H.264 video macro blocks is intra-frame coding;
ascertaining that CU of the H.265 CTU corresponding to a certain first video macro block is 8×8 mode if classification mode of the certain first video macro block is 4×4;
grouping the 16 H.264 video macro blocks into four sets of video macro blocks, each set of video macro blocks comprising four of the H.264 video macro blocks, and shape of each set of video macro blocks is square;
ascertaining that CU of the H.265 CTU corresponding to a certain set of video macro blocks except the first video macro block is 16×16 mode if the certain set of video macro blocks comprises first video macro blocks of 4×4 classification mode;
ascertaining that CU of the H.265 CTU corresponding to four video macro blocks of 16×16 classification mode is 16×16 mode if the certain set of video macro blocks comprises four video macro blocks of 16×16 classification mode, prediction directions of which are different;
ascertaining that CU of the H.265 CTU corresponding to each video macro block in the N sets of video macro blocks is 32×32 mode as N is smaller than 4, and ascertaining that CU of the H.265 CTU corresponding to each video macro block in the N sets of video macro blocks is 64×64 mode as N is equal to 4, if each of N sets of video macro blocks comprises four video macro blocks of 16×16 classification mode, prediction directions of which are the same.

13. The electronic apparatus according to claim 12, wherein, ascertaining PU of the H.265 CTU according to the ascertained CU of the H.265 CTU and preset intra prediction unit PU ascertainment relationship comprises:
ascertaining that PU of the H.265 CTU is N×N mode if CU of the H.265 CTU is 8×8 mode, wherein prediction direction of PU of the H.265 CTU is mode H.265 26 if intra-frame prediction direction of the H.264 video macro block is mode H.264 0, prediction direction of PU of the H.265 CTU is mode H.265 10 if intra-frame prediction direction of the H.264 video macro block is mode H.264 1, prediction direction of PU of the H.264 video macro block is selected from the best one of mode H.265 0 and mode H.265 1 if intra-frame prediction direction of the H.264 video macro block is mode H.264 2, prediction direction of PU of the H.264 video macro block is selected from the best one of mode H.265 31, mode H.265 32 and mode H.265 33 if intra-frame prediction direction of the H.264 video macro block is mode H.264 3, prediction direction of PU of the H.264 video macro block is selected from the best one of mode H.265 17, mode H.265 18 and mode H.265 19 if intra-frame prediction direction of the H.264 video macro block is mode H.264 4, prediction direction of PU of the H.264 video macro block is selected from the best one of mode H.265 22, mode H.265 23 and mode H.265 24 if intra-frame prediction direction of the H.264 video macro block is mode H.264 5, prediction direction of PU of the H.264 video macro block is selected from the best one of mode H.265 12, mode H.265 13 and mode H.265 14 if intra-frame prediction direction of the H.264 video macro block is mode H.264 6, prediction direction of PU of the H.264 video macro block is selected from the best one of mode H.265 28, mode H.265 29 and mode H.265 30 if intra-frame prediction direction of the H.264 video macro block is mode H.264 7, and prediction direction of PU of the H.264 video macro block is selected from the best one of mode H.265 3, mode H.265 4, mode H.265 5 and mode H.265 6 if intra-frame prediction direction of the H.264 video macro block is mode H.264 8;
ascertaining that PU of the H.265 CTU is 2N×2N mode if CU of the H.265 CTU is 16×16 mode, 32×32 mode or 64×64 mode, wherein prediction direction of PU of the H.264 video macro block is mode H.265 26 if intra-frame prediction direction of the H.264 video macro block is mode H.264 0, prediction direction of PU of the H.264 video macro block is mode H.265 10 if intra-frame prediction direction of the H.264 video macro block is mode H.264 1, prediction direction of PU of the H.264 video macro block is mode H.265 0 if intra-frame prediction direction of the H.264 video macro block is mode H.264 2, and prediction direction of PU of the H.264 video macro block is mode H.265 1 if intra-frame prediction direction of the H.264 video macro block is mode H.264 3.

14. The electronic apparatus according to claim 12, wherein, ascertaining TU of the H.265 CTU according to the ascertained CU of the H.265 CTU and preset transformation unit TU ascertainment relationship comprises:
selecting TU of the H.265 CTU to be four 32×32 modes if CU of the H.265 CTU is 64×64 mode;
selecting TU of the H.265 CTU to be 32×32 mode if CU of the H.265 CTU is 32×32 mode;
selecting TU of the H.265 CTU to be 16×16 mode if CU of the H.265 CTU is 16×16 mode;
selecting TU of the H.265 CTU to be 8×8 mode if CU of the H.265 CTU is 8×8 mode.

15. The electronic apparatus according to claim 11, wherein, if the encoding type of the 16 H.264 video macro blocks is inter-frame coding, transcoding the 16 H.264 video macro blocks into one H.265 CTU according to preset inter-frame transcoding correspondence comprises:
ascertaining CU of the H.265 CTU according to preset inter-frame coding unit CU ascertainment relationship if the encoding type of the 16 H.264 video macro blocks is inter-frame coding;
ascertaining PU of the H.265 CTU according to the ascertained CU of the H.265 CTU and preset inter-frame PU ascertainment relationship;
ascertaining TU of the H.265 CTU according to the ascertained CU of the H.265 CTU and preset transformation unit TU ascertainment relationship.

16. The electronic apparatus according to claim 15, wherein, if the encoding type of the 16 H.264 video macro blocks is inter-frame coding, ascertaining CU of the H.265 CTU according to preset inter-frame coding unit CU ascertainment relationship comprises:
if the encoding type of the 16 H.264 video macro blocks is inter-frame coding, grouping the 16 H.264 video macro blocks into four sets of video macro blocks, each set of video macro blocks comprising four of the H.264 video macro blocks, and shape of each set of video macro blocks is square;
ascertaining classification mode of each of the 16 H.264 video macro blocks;
ascertaining that CU of the H.265 CTU corresponding to video macro block in the certain set of video macro blocks is 8×8 mode if a certain set of video macro blocks comprises video macro blocks of 8×8, 8×4, 4×8 or 4×4 classification mode;
ascertaining that CU of the H.265 CTU corresponding to video macro block in the certain set of video macro blocks is 16×16 mode if none of the certain set of video macro blocks is video macro block of 16×16 classification mode or if a difference between motion vectors MV of four video macro blocks in the certain set of video macro blocks is larger than preset motion vector deviation range threshold;
if each of N sets of the video macro blocks comprises four video macro blocks of 16×16 classification mode, prediction directions of which are the same, ascertaining that CU of the H.265 CTU corresponding to each video macro block in the N sets of video macro block is 32×32 mode as N is smaller than 4 and the difference between motion vectors MV of four video macro blocks in each of the N sets of the video macro blocks is smaller than or equal to preset motion vector deviation range threshold, and ascertaining that CU of the H.265 CTU corresponding to each video macro block in the N sets of video macro blocks is 64×64 mode as N is equal to 4.

17. The electronic apparatus according to claim 16, wherein, ascertaining PU of the H.265 CTU according to the ascertained CU of the H.265 CTU and preset inter-frame PU ascertainment relationship comprises:
if CU of the H.265 CTU is 8×8 mode, ascertaining that PU of the H.265 CTU is 2N×N mode if the H.264 video macro block corresponding to CU of the H.265 CTU is 8×4 classification mode, ascertaining that PU of the H.265 CTU is N×2N mode if the H.264 video macro block corresponding to CU of the H.265 CTU is 4×8 classification mode, and ascertaining that PU of the H.265 CTU is N×N mode if the H.264 video macro block corresponding to CU of the H.265 CTU is 4×4 classification mode;
if CU of the H.265 CTU is 16×16 mode, ascertaining that PU of the H.265 CTU is 2N×2N mode if the H.264 video macro block corresponding to CU of the H.265 CTU is 16×16 classification mode, ascertaining that PU of the H.265 CTU is 2N×N mode if the H.264 video macro block corresponding to CU of the H.265 CTU is 16×8 classification mode, and ascertaining that PU of the H.265 CTU is N×2N mode if the H.264 video macro block corresponding to CU of the H.265 CTU is 64×64 classification mode;
ascertaining that PU of the H.265 CTU is 2N×2N mode if CU of the H.265 CTU is 32×32 or 64×64 mode;
selecting MV of the H.264 video macro block to be MV of PU of the H.265 CTU if MV of the H.264 video macro block corresponding to CU of the H.265 CTU is the same;
selecting reference MV, researching new MV according to the reference MV, and setting the new MV as MV of PU of the H.265 CTU if MV of the H.264 video macro block corresponding to CU of the H.265 CTU is different.

18. The electronic apparatus according to claim 16, wherein, ascertaining TU of the H.265 CTU according to the ascertained CU of the H.265 CTU and preset transformation unit TU ascertainment relationship comprises:
selecting TU of the H.265 CTU to be four 32×32 modes if CU of the H.265 CTU is 64×64 mode;
selecting TU of the H.265 CTU to be 32×32 mode if CU of the H.265 CTU is 32×32 mode;
selecting TU of the H.265 CTU to be 16×16 mode if CU of the H.265 CTU is 16×16 mode;
selecting TU of the H.265 CTU to be 8×8 mode when CU of the H.265 CTU is 8×8 mode

19. The electronic apparatus according to claim 18, wherein, if the encoding type of the 16 H.264 video macro blocks is intra-frame coding, transcoding the 16 H.264 video macro blocks into a H.265 coding tree unit (CTU) according to preset intra-frame transcoding correspondence comprises:
ascertaining CU of the H.265 CTU according to preset intra-frame coding unit CU ascertainment relationship if the encoding type of the 16 H.264 video macro blocks is intra-frame coding;
ascertaining PU of the H.265 CTU according to the ascertained CU of the H.265 CTU and preset intra prediction unit PU ascertainment relationship;
ascertaining TU of the H.265 CTU according to the ascertained CU of the H.265 CTU and preset transformation unit TU ascertainment relationship.
